(19) United States
(12) Patent Application Publication
(10) Pub. No.: US 2004/0060408 A1
(43) Pub. Date: Apr. 1, 2004

(54) Light-weight mechanical spacer for slitting

(76) Inventor: Wilbur C. Thomas, Dearborn, MI (US)

Correspondence Address: HARNESS, DICKEY & PIERCE, P.L.C., P.O. BOX 828, BLOOMFIELD HILLS, MI, 48303, US

(21) Appl. No.: 10/676,710

(22) Filed: Oct. 1, 2003

Related U.S. Application Data
(60) Provisional application No. 60/452,874, filed on Mar. 7, 2003.
(60) Provisional application No. 60/415,038, filed on Oct. 1, 2002.

(51) Int. Cl. B26D 7/06; B26D 1/12

(52) U.S. Cl. 83/425.3; 83/664

(57) ABSTRACT

A light-weight mechanical spacer is provided and includes first and second housing plates and a plurality of shafts or posts. The housing plates include a generally circular shape and include a coaxial bore formed therethrough for receiving an arbor. The first and second housing plates are connected by a plurality of shafts to both define the overall width of the spacer as well as to provide increased strength. The shafts enable the light-weight design as they effectively replace the solid mass of steel commonly found in conventional spacers.

### CROSS-REFERENCE TO RELATED APPLICATIONS

This application claims the benefit of U.S. Provisional Application Nos. 60/415,038, filed on Oct. 1, 2002 and 60/452,874 filed on Mar. 7, 2003. The disclosure of these applications is incorporated herein by reference.

### FIELD OF THE INVENTION

The present invention relates to mechanical spacers, and more particularly, to a light-weight mechanical spacer for use in a metal slitting operation.

### BACKGROUND OF THE INVENTION

In slitting operations such as metal slitting and the like, it is imperative to be able to provide a wide range of steel widths to consumers. Further, it is desirable that a single slitting machine be capable of quickly and inexpensively slitting a coil of metal into a plurality of different widths for various applications. Further yet, it is desirable to maintain tight tolerances on the cut metal to ensure that the metal will be usable in its particular application and will perform as desired. To these ends, spacers play a significant role in the conventional slitting of metal.

Conventional slitter tooling consists generally of two sets of round spacers and a series of knives. The spacers and knives are received by upper and lower arbors, whereby the upper arbor is offset and opposed from the lower arbor. In operation, a metal coil is unwound and passes between the upper and lower arbors for slitting. Specifically, as the coil passes between the arbors, the meal is sheared into strips of a predetermined width through the cooperation of the knives on each of the upper and lower arbor. In this manner, the horizontal distance between a pair of knives determines the output width of the strip.

The distance between a pair of knives is commonly referred to as horizontal clearance and is generally set by employing a series of mechanical spacers. By way of example, if a two inch wide strip is desired, the top and bottom arbors will be packed with a series of knives and two inch spacers to provide the desired horizontal clearance between each knife. Having each knife separated by a two-inch spacer results in a sheet of metal originally measuring twenty-four inches in width prior to slitting, being cut into a series of twelve two-inch strips after slitting.

Conventional spacers are commonly constructed of solid steel and generally include a central bore for receiving an arbor. The overall width of the spacer determines the horizontal clearance between the knives and ultimately the width of the strip exiting the slitter, as previously discussed. Conventional spacers, while adequately maintaining the horizontal clearance between the knives, are typically very heavy and, as a result, difficult to change. Further, because the solid steel spacers are heavy and difficult to maneuver, the time required to make a tooling change, as required to cut different strip widths, is increased, thus increasing cost and waste.

Because the requirements for different strip widths change throughout a typical day, and because slitting operations produce varying widths on the same tooling, the rate at which a machine is re-tooled to cut different widths of metal is very important. As can be appreciated, the longer it takes to change a series of spacers and knives between operations, the more time the machine sits idle. Such increases in downtime generally decreases the overall efficiency of the slitting operation and will ultimately decrease profits and productivity.

Therefore, a spacer that improves the efficiency of a slitting operation by enabling a quicker change over between varying strip widths, while maintaining a tight tolerance, is desirable in the industry.

### SUMMARY OF THE INVENTION

Accordingly, the present invention provides a light-weight mechanical spacer constructed out of first and second housing plates and a plurality of shafts or posts. The housing plates define a generally circular shape and include a coaxial bore formed therethrough for receiving an arbor. The first and second housing plates are connected by a plurality of shafts to both define the overall width of the spacer as well as to provide increased strength. The shafts enable the light-weight design as they effectively replace the solid mass of steel commonly found in conventional spacers. The light-weight spacer effectively reduces the amount of weight that must be lifted each time the tooling requires changing. In this manner, the light-weight spacer enables a quicker tooling change-over, thereby increasing efficiency and improving the overall production of a slitting operation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first embodiment of a mechanical spacer in accordance with the principals of the present invention;

FIG. 2 is a perspective view of a second embodiment of a mechanical spacer in accordance with the principals of the present invention;

FIG. 3 is a graphical representation of the first and second mechanical spacers of FIGS. 1 and 2 as used in an exemplary slitting operation;

FIG. 4 is a second embodiment of a mechanical spacer in accordance with the principals of the present invention;

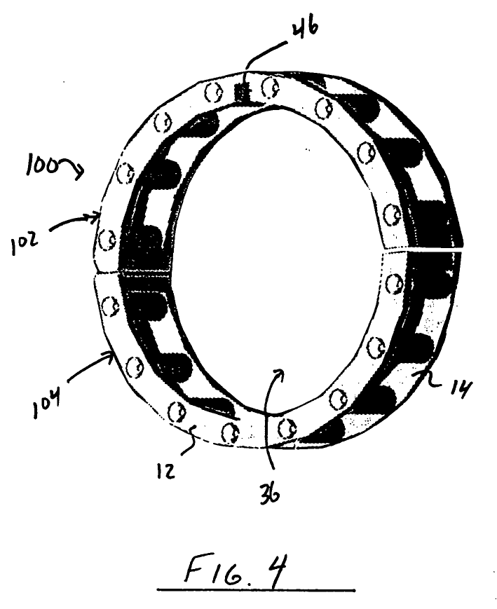

FIG. 5 is a side view of a mechanical space in accordance with the principals of the present invention incorporated onto an arbor; and

FIG. 6 is a side view of a mechanical spacer in accordance with the principals of the present invention incorporated onto an arbor.

### DETAILED DESCRIPTION OF THE PREFERRED EMBODIMENTS

The following description of the preferred embodiments is merely exemplary in nature and is in no way intended to limit the invention, its application, or uses.

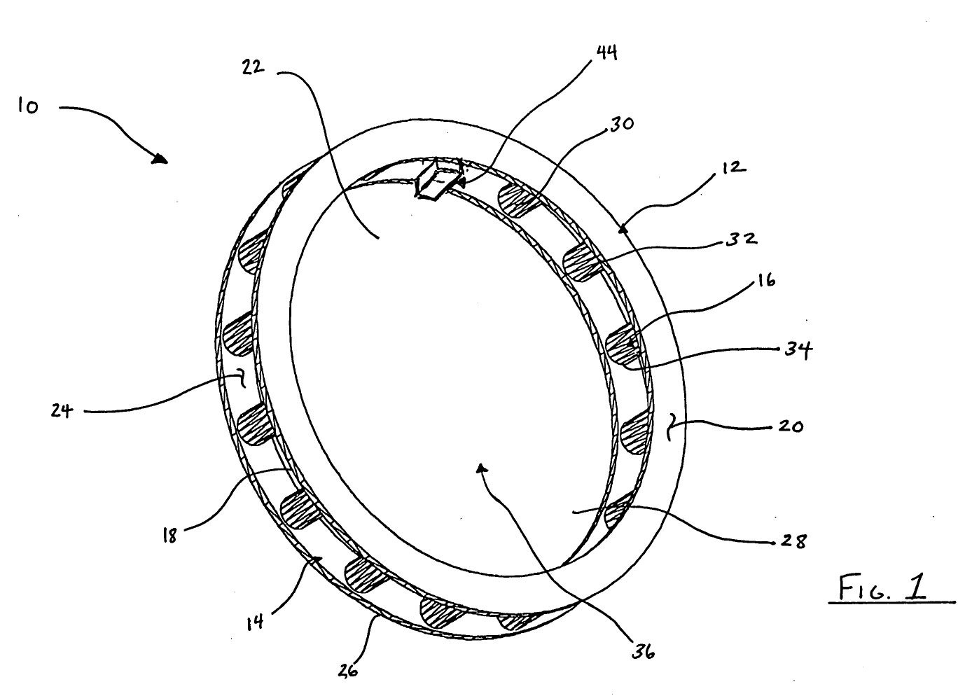

With reference to the FIG. 1, a mechanical spacer 10 is provided and includes a first housing plate 12, a second housing plate 14, and a plurality of shafts 16. The shafts 16 fixedly connect the first and second housing plates 12 and 14 and provide a predetermined spaced relationship therebetween.

The first housing plate 12 includes a generally circular shape having an inner and outer surface 18 and 20 and a first bore 22 formed therethrough. The second housing plate 14 includes a generally circular shape and includes an inner and outer surface 24 and 26 and a second bore 24 formed therethrough. The first and second housing plates 12 and 14 are fixedly connected by shafts 16 and are held in a fixed relationship relative one another thereby.

The shafts 16 serve to interconnect the first and second housing plates 18, 20 and also to set the overall width of the spacer 10, as will be discussed further herein below. The shafts 16 include a generally cylindrical body 30 and a first and second end 32 and 34. The length of each shaft 16 determines the space between the first and second housing plates 12 and 14 and, as such, determines the overall width of the spacer 10 as measured between the outer surface 20 of the first housing plate 12 and the outer surface 26 of the second housing plate 14. The first end 32 of each shaft 16 is received by the inner surface 18 of the first housing plate 12 and is fixedly mounted thereto by a suitable means such as a weld or a press fit. The second end 34 of each shaft 16 is received by the inner surface 24 of the second housing plate 14 and is similarly mounted thereto by a suitable means such as a weld or a press fit. While a weld and a press fit are disclosed, it should be understood that any suitable manner of attaching the post 16 to the inner surfaces 18 and 24 of the first and second housing plates 12 and 14 is anticipated and should be considered within the scope of the present invention. It should further be understood that while a cylindrical body 30 is disclosed, the posts 16 could have any suitable cross-sectional shape such as, but not limited to, a square or triangular shape, and should be considered within the scope of the present invention.

Having a shaft 16 fixedly attached to the inner surface 18 of the first housing plate 12 and concurrently to the inner surface 24 of the second housing plate 14 sets the relative relationship between the first and second housing plates 12 and 14. In an effort to strengthen the structure of the mechanical spacer 10, a plurality of shafts 16 are included and are similarly attached to the first and second housing plates 12 and 14, as previously described. In this manner, the mechanical spacer 10 includes a plurality of shafts 16 radially spaced from a central axis to support the first and second housing plates 12 and 14 and to provide an arrangement for setting the overall width of the mechanical spacer 10.

To change the width of the mechanical spacer 10, the shafts 16 can be constructed of varying lengths depending on the particular application and desired width of the spacer 10. Specifically, at the time of manufacturing, the shafts 16 can be adjusted (i.e. shortened or lengthened) prior to their assembly to the first and second housing plates 12 and 14, whereby the amount of adjustment will be determined by the desired overall width of the mechanical spacer 10. It should be understood that the lengths of the shafts 16 must be uniform for each mechanical spacer 10. Providing the shafts 16 with a uniform length ensures that the outer width of the mechanical spacer 10 is constant, thereby providing an accurate and reliable tolerance, as will be discussed further below.

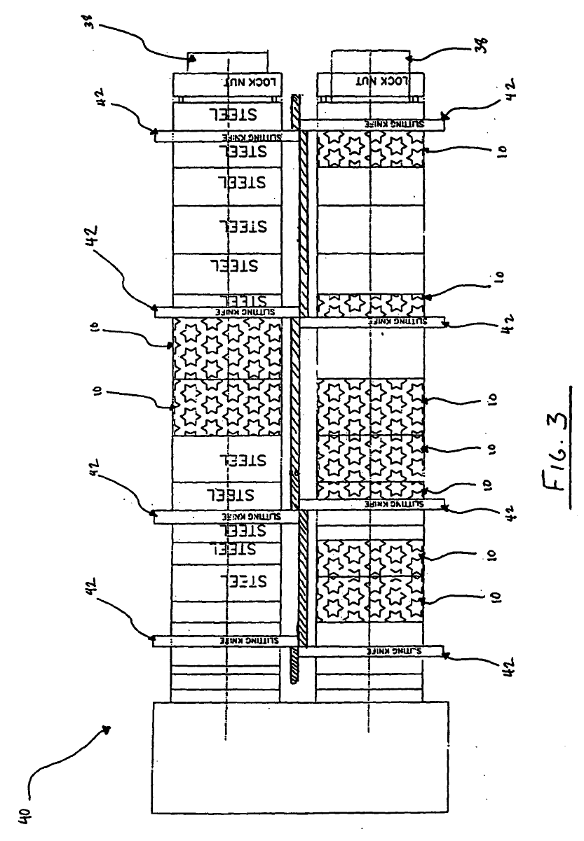

Upon attachment of the first housing plate 12 to the second housing plate 14, it is imperative that the first bore 22 of the first housing plate 12 is coaxially aligned with the second bore 28 of the second housing plate 14. The alignment of the first and second bore 22 and 28 forms a central bore 36 extending through the mechanical spacer 10. The central bore 36 receives an arbor 38, whereby the arbor 38 is a generally elongate cylindrical member. In one embodiment, the arbor is rotatably driven by a slitter tool 40 and serves to transmit the rotation from the slitter tool 40 to a series of knives 42 as best shown in FIG. 3. The spacing between the knives 42 determines the width of a coil of steel (not shown) after slitting, whereby the distance between the knives 42 is governed by the position of the spacers 10. Because the spacing of the knives 42 is critical to a successful slitting operation with regard to maintaining tolerances and the like, the mechanical spacers 10 must rotate with the arbor 38 and maintain their relative position throughout the operation.

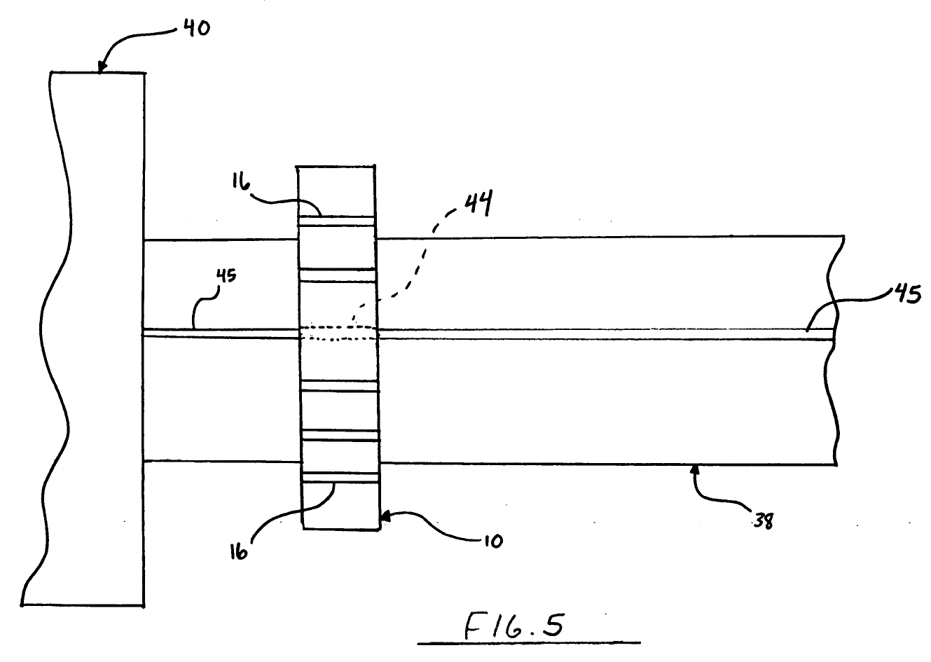

In one embodiment, the first and second housing plates 12 and 14 have a key 44 disposed therebetween extending from an inner surface of bore 36 generally towards a central axis of rotation of the mechanical spacer 10, as best shown in FIG. 1. The key 44 is received by a mating slot 45 formed in the arbor 38 such that as the mechanical spacer 10 is slid onto the arbor 38 the key 44 is concurrently received by the slot 45, as best shown in FIG. 5. In this manner, relative rotation between the arbor 38 and the mechanical spacer 10 is prohibited. It should be noted that the mechanical spacer 10 may be used concurrently with another mechanical spacer 10 to accomplish a relative distance between two knives 42 generally equal to the combined widths of the two mechanical spacers 10, as best shown in FIG. 3. In this manner, the cooperation of the key 44 and the slot 45 serves to align the spacers 10 and ensure that the shafts 16 of the respective spacers 10 are aligned. Alignment of the shafts 16 ensures that the compressive strength of spacers 10 together is maximized. Specifically, as load is applied to either spacer 10, it is effectively transmitted by the shafts therebetween. This relationship maintains the integrity of the individual spacers 10 and ensures a slitting operation that is capable of maintaining a tight tolerance.

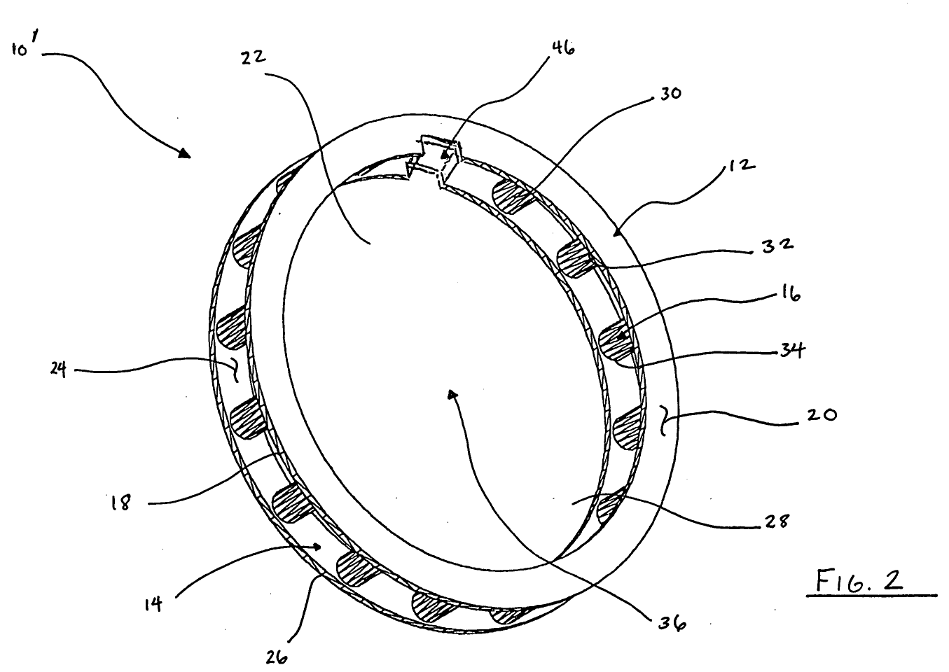

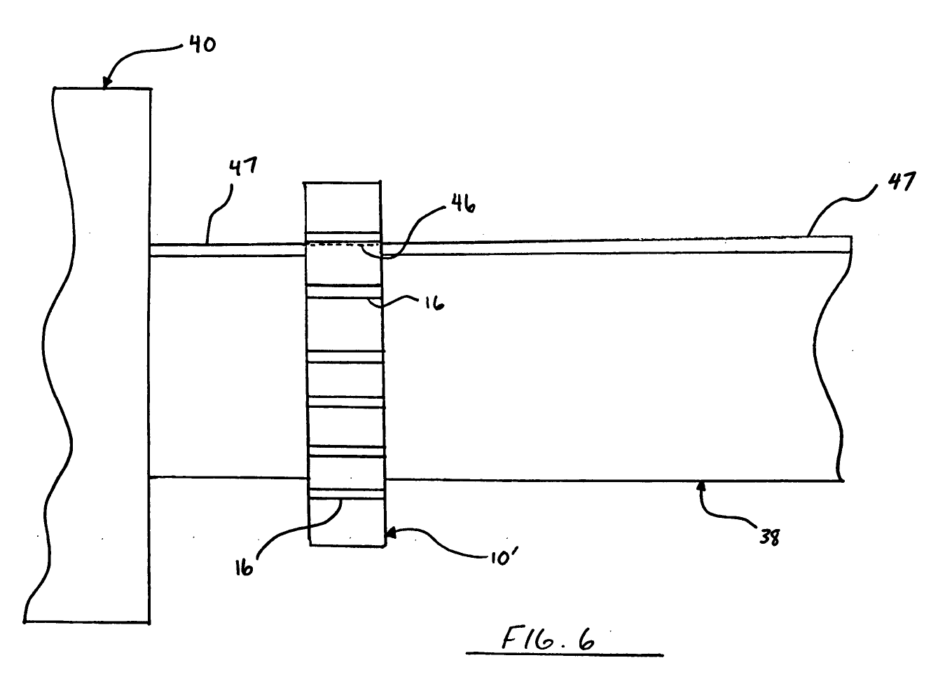

With reference to FIGS. 2 and 6, a mechanical spacer in accordance with a second embodiment is illustrated and generally identified at reference character 10′. In view of the related combination between the embodiments of FIGS. 1 and 2, like reference numbers will be used to identify like elements. In the second embodiment, the first and second housing plates 12 and 14 have a recess or keyway 46 disposed therebetween extending across the width of the spacer 10′ longitudinally along central bore 36 as best shown in FIG. 2. The keyway 46 receives a key 47 disposed generally along a length of the arbor 38 such that as the mechanical spacer 10′ is slid onto the arbor 38 the keyway 46 receives the key 47. In this manner, relative rotation between the arbor 38 and the mechanical spacer 10′ is prohibited.

It should again be noted that the mechanical spacer 10′ may be used concurrently with another mechanical spacer 10′ to accomplish a relative distance between two knives 42 generally equal to the combined widths of the two mechanical spacers 10′, as best shown in FIG. 3. In this manner, the cooperation of the keyway 46 and the key 47 serves to align the spacers 10′ and ensure that the shafts 16 of the respective spacers 10′ are aligned. Alignment of the shafts 16 ensures that the compressive strength of spacers 10′ together is maximized. Specifically, as load is applied to either spacer 10′, it is effectively transmitted by the shafts therebetween. This relationship maintains the integrity of the individual spacers 10′ and ensures a slitting operation that is capable of maintaining a tight tolerance.

The foregoing description enables a traditional spacer to be replaced by a lighter-weight mechanical spacer 10. Specifically, by replacing the traditional solid steel spacer with a mechanical spacer 10 having support posts 16 in the place of a solid steel mass, suitable strength characteristics can be achieved using less material. In an effort to fill the voids between the first and second housing plates 12, 14 and the posts 16, the mechanical spacer 10 may be optionally provided with a suitable material such as, but not limited to, a structural foam or adhesive. The filler material used should have a lower weight than the steel traditionally used to realize the benefit of the light-weight design and will serve to give the outer edge of the mechanical spacer 10 a uniform and smooth appearance. It should be understood that the filler material is optional and bears no weight on the performance of the present invention. The material may increase the overall strength of the spacer 10 but the intent of adding the material is for aesthetic purposes only.

While the first and second housing plates 12 and 14 have been described as including a keyway 46 for interaction with key 47 formed on arbor 38, it should be understood that the spacers 10 of the present invention could include first and second apertures 22 and 28 having a generally constant circular shape. In this manner, apertures 22 and 28 are matingly received by the circular-shaped arbor 38 and are held in relative position along the arbor 38 due to the interaction between adjacent spacers 10 and knives 42, thereby obviating the necessity for a keyway 46 and key 47. In other words, in situations where a key 47 is not available on an arbor 38, the spacers 10 of the present invention are still usable provided each spacer 10 is sandwiched between adjacent spacers 10 or knives 42.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mechanical spacer for use in a slitting operation, the mechanical spacer comprising:
a first housing plate;
a second housing plate; and
a plurality of shafts interconnecting the first and second housing plates, the shafts each having an equal length such that the first and second housing plates are fixedly held in a parallel relationship relative one another.

2. The mechanical spacer of claim 1, wherein the first and second housing plates include a generally circular shape having an aperture coaxially formed therethrough.

3. The mechanical spacer of claim 2, wherein the aperture is for receiving an arbor for rotation therewith.

4. The mechanical spacer of claim 3, wherein the aperture includes a recess formed through the first and second housing plates for interaction with a key formed on the arbor to prevent relative rotation therebetween.

5. The mechanical spacer of claim 3, wherein the aperture includes a key interconnecting the first and second housing plates for interaction with a recess formed on the arbor to prevent relative rotation therebetween.

6. The mechanical spacer of claim 4, wherein the interaction of the key and the recess serves to align multiple mechanical spacers along the arbor such that the shafts of the individual spacers are co-aligned.

7. The mechanical spacer of claim 5, wherein the interaction of the key and the recess serves to align multiple mechanical spacers along the arbor such that the shafts of the individual spacers are co-aligned.

8. A slitter tool comprising:
an upper arbor defining a first longitudinal axis and including a first engagement element;
a lower arbor defining a second longitudinal axis and including a second engagement element; and
at least one mechanical spacer matingly received by each of the upper and lower arbors, the mechanical spacers comprising:
a first housing plate and a second housing plate, the first and second housing plates defining a third engagement element; and
a plurality of shafts interconnecting the first and second housing plates, the shafts each having an equal length such that the first and second housing plates are fixedly held in a parallel relationship relative one another.

9. The slitter tool of claim 8, wherein the first engagement element includes a slot formed in the upper arbor along the first longitudinal axis.

10. The slitter tool of claim 8, wherein the second engagement element includes a slot formed in the lower arbor along the second longitudinal axis.

11. The slitter tool of claim 8, wherein the first engagement element includes a key extending from an outer surface of the upper arbor, the key extending the length of the upper arbor along the first longitudinal axis.

12. The slitter tool of claim 8, wherein the second engagement element includes a key extending from an outer surface of the lower arbor, the key extending the length of the lower arbor along the second longitudinal axis.

13. The slitter tool of claim 8, wherein the first and second housing plates include a generally circular shape having an aperture coaxially formed therethrough.

14. The slitter tool of claim 13, wherein the third engagement element includes a recess formed through the first and second housing plates for interaction with the first and second engagement elements of the upper and lower arbors to prevent relative rotation therebetween.

15. The slitter tool of claim 13, wherein the third engagement element comprises a key extending from an inner diameter of the aperture, the key operable to be matingly received by the first and second engagement elements of the upper and lower arbors to prevent relative rotation therebetween.

16. The slitter tool of claim 13, wherein the upper arbor is adapted to matingly receive the aperture of the first and second housing plates of a first mechanical spacer and the lower arbor is adapted to matingly receive the aperture of the first and second housing plates of a second mechanical spacer.

17. The slitter tool of claim 8, wherein the mechanical spacers define a plurality of paths between the upper and lower arbors.

18. The slitter tool of claim 8, wherein each of the upper and lower arbors include a plurality of knives, the knives disposed along each of the upper and lower arbors and spaced apart by the mechanical spacers at a predetermined distance.

19. A method of slitting metal comprising:
positioning an upper arbor in proximity to a lower arbor to define a passageway therebetween;
inserting a first set of cutting knives onto each of the upper and lower arbors, the knives extending into the passageway between the upper and lower arbors;
positioning a first mechanical spacer proximate the first set of cutting knives on both the upper and lower arbors, the mechanical spacers each including a first and second housing plate joined by a plurality of shafts;
positioning a second set of cutting knives proximate the first mechanical spacer on both the upper and lower arbors to define a distance between the first and second cutting knives substantially equivalent to a width of each mechanical spacer;
rotating the upper and lower arbors such that each of the first and second knives and mechanical spacers rotate therewith;
passing a sheet of metal through the passageway for interaction with the knives such that the metal is cut into strips having a width substantially equivalent to that of the mechanical spacers.

20. The method of slitting metal of claim 19, further comprising the step of positing a second mechanical spacer proximate the first mechanical spacer on at least one of the upper and lower arbors to achieve a desired slit thickness.

21. The method of slitting metal of claim 20, wherein the mechanical spacers each include a keyed portion for mating engagement with a keyed portion of each of the upper and lower arbors.

22. The method of slitting metal of claim 21, wherein the keyed section is operable to coaxially align the first and second mechanical spacers relative to the upper and lower arbors.

23. The method of slitting metal according to claim 21, wherein the keyed section coaxially aligns each of the individual shafts of the first and mechanical spacers.
